(19) United States
(12) Patent Application Publication
(10) Pub. No.: US 2006/0003072 A1
(43) Pub. Date: Jan. 5, 2006

(54) Dehydrated edible beans in bread

(76) Inventors: Ali A. Elmusa, Leawood, KS (US); Charles A. Morris, Overland Park, KS (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/173,558

(22) Filed: Jul. 1, 2005

Related U.S. Application Data
(60) Provisional application No. 60/585,394, filed on Jul. 2, 2004.

(51) Int. Cl. A21D 10/00

(52) U.S. Cl. 426/549

(57) ABSTRACT

A bread product low in carbohydrate content is formed using an ingredient made from dehydrated beans. The ingredient is a reconstitutable bean powder particulate, and has been found to add flavor to the bread product. It can also partially substitute for wheat-based flour in a dough composition. The reconstitutable bean powder particulate may be made by a process including conditioning beans by hydration, cooking the conditioned beans, dehydrating the cooked beans, then comminuting the particulates to particular ranges.

### CROSS REFERENCE TO RELATED APPLICATIONS

This application claims the benefit of U.S. provisional patent application Ser. No. 60/585,394 filed Jul. 2, 2004, which is incorporated in its entirety by reference herein.

### FIELD OF THE INVENTION

Bread products, doughs, ingredients used for making bread products, and methods of making bread products are provided.

### BACKGROUND OF THE INVENTION

The method of making bread is well known in the art and has been practiced for thousands of years. A dough composition is mixed together and heated for an amount of time sufficient to bake the dough, thereby allowing the dough to leaven by a chemical reaction that releases a gas and expands the bread to a sponge-like structure. A typical bread dough includes flour, sugar, water, shortening agents, salt, conditioners, and leavening agents.

Flour is a powdery substance derived from the grinding and sifting of a grain, typically a wheat grain, and it provides the structural matrix of dough as well as the matrix for the baked bread product resulting therefrom. A component of flour, gluten, is a mixture of many proteins and serves as flour's primary agent for providing the structural integrity to the dough and resultant bread product. Gluten and gluten-forming proteins, such as prolamins, gliadin, and glutenin, provide elasticity, cohesiveness and binding properties to the bread dough. The elasticity of the gluten further allows expansion of the dough upon leavening. Bread products, in particular, tortillas, crackers, and other flat breads, often require sheeting, rolling, or flattening prior to cutting or die cutting of the dough. The gluten in flour, with its binding and elastic properties, is essential to the proper formation of the bread product.

The production of flour from grain is also well known in the art. Flour is typically milled by roller processes in which seeds are alternatively put through a series of high-speed steel rollers and a mesh sifter. The rollers crack the grain, allowing the endosperm (the largest part of the seed) to be separated from the bran and germ. The endosperm is then ground to the desired consistency. For whole grain flours, the bran and germ are returned to the flour at the end of the process. This is simply a mechanical process consisting of cracking, separating, and thereafter grinding the desired portion to the appropriate consistency.

Grains, the flour derived therefrom, and the resulting bread product are rich in carbohydrates. Carbohydrates are formed of a polymeric chain of saccharides, or sugar molecules. Carbohydrates are a vital source of energy for the human body as their breakdown in the body provides a source of saccharides, particularly glucose, which is the primary source of cellular energy. Glucose is in turn absorbed into the blood and transported to the body tissues for use or storage in the liver and muscles as glycogen, which is comprised of long strings of glucose.

Despite the importance of carbohydrates as an energy source, recent diet trends have led to an increased consumer demand for foods that are compatible with a diet which is low in carbohydrate content. Bread products and other grain-based products with a high carbohydrate content have accordingly seen reduced consumer demand in the marketplace. There is a need, therefore, for bread products with reduced carbohydrate content, desirable taste characteristics, and increased protein and fiber content in comparison to wheat flour bread products.

For a number of reasons, including the reduction of carbohydrate content of a bread product, flour substitutes not derived from grain or wheat have been developed. Flour substitutes derived from non-wheat sources are more difficult to produce and are typically required to undergo additional processes beyond the simple separation and grinding necessary for wheat grain. Soy flour, for example, is derived from soybeans and is made by roasting the soybeans and subsequently grinding the roasted soybeans into a fine powder.

In some instances, bread made using soy flour can result in undesirable characteristics. While soy flour provides increased protein to a bread composition in relation to a wheat-based flour, it can sometimes have an undesirable taste that adversely affects the bread products. Bread products with soy flour can also be more dense than a bread product derived from a wheat-based flour and, accordingly, have a texture that is sometimes inferior to bread made from a wheat-based flour. Furthermore, doughs which are high in soy content sometimes do not bind well, are sticky, and are not pliable. Bread doughs made from soy powder often do not machine properly since the dough often adheres to rollers and wires of dough sheeter heads and such dough can be difficult to press out to a uniform thickness. These disadvantages have accordingly limited the use of soy flour within bread dough compositions.

U.S. Pat. No. 6,479,089 to Cohen (“Cohen '089”) attempts to solve the problems associated with soy flour by incorporating a pre-gelatinized starch within a dough composition in addition to a soy component. The pre-gelatinized starches disclosed as preferable are rice starch, arrowroot starch, pea starch, tapioca starch, or potato starch. The soy component is present in the compositions of Cohen '089 in amounts ranging from about 60% to about 90% by weight of the dry ingredients, and the pre-gelatinized starch comprises from about 10% to about 40% by weight of the dry ingredients to which water and other liquid ingredients are added. While Cohen '089 may improve the quality of a bread dough composition based on a soy flour, it does so by adding a pre-gelatinized starch component, thus adding processing steps and still including many of the negative aspects associated with products made from soybean flour.

U.S. Pat. No. 5,789,012 to Slimak (“Slimak '012”) discloses various substitutes for wheat flour; i.e., flours prepared from a variety of different tubers, including white sweet potatoes, cassaya, edible aroids, tropical yams, Lotus, arrowroot, buckbean, and amaranth. The disclosure of Slimak '012 is directed to a new process for preparing the flour from tubers; the process includes the steps of: (1) peeling and washing the tubers, (2) shredding the washed tubers, (3) dehydrating the shredded tubers, and then (4) comminuting the tubers to a fine power. This process may be repeated with an additional step of partially or completely cooking the comminuted power. Presoaking and/or any step involving hydration of the tubers is undesirable, as a product with a low moisture content is preferred. Furthermore, the size of the flour particle encompasses a large range, with no apparent criticality to a preferred size; e.g., the range includes particles which may pass through a screen with openings of 0.025 mm (25 microns) to particles which may pass through a screen with openings of 0.6 mm (600 microns). Most examples describe a particle of about 0.38 mm (380 microns) being used in compositions.

The disclosure of Slimak '012 is directed to a flour substitute for people who are allergic to wheat flour, but does not provide a bread product with palatability and textural properties suitable for mass consumer appeal. Furthermore, Slimak '012 does not disclose the use of a bean powder in a bread dough composition. Soy flour as a substitute for wheat flour, therefore, falls short in many categories, principally flavor. There is a need for ingredients which provide increased fiber and protein content in bread while also providing the bread with a desirable taste.

Flavoring ingredients have also been added into bread products, particularly tortilla bread products, in order to provide increased palatability. Some flavors which have been added to breads and tortillas include sun dried tomato, garlic, spinach, herbs and spices, as well as a wide variety of other flavoring ingredients. Vegetables and legumes are very desirable to be added as ingredients because, in addition to providing a desirable taste to the bread, they also provide an efficient food and nutrient source, as they provide essential vitamins and minerals, are high in protein and fiber, and are low in fat and carbohydrates. Legumes, beans in particular, are high in protein and fiber content, and additionally have a sugar profile with pro-biotic properties. Flavoring ingredients are typically added to the composition at a very low percentage, usually less than about 2%-3% by weight of the dry dough mixture.

It is desirable to add the flavoring ingredients into a dough composition at greater amounts, but this presents several problems. Primarily, the addition of the specialty ingredients necessitates removing flour from the dough. As previously mentioned, flour, gluten in particular, provides the overall matrix for the dough composition and the finished bread product. As additional ingredients are added and the flour is removed, the dough and the finished bread product lose cohesiveness and structural integrity. Furthermore, when flour is removed from a bread dough, it often necessitates adding additional water to the dough composition, which can also adversely affect the bread, as it creates a dough which is more difficult to manage because of the decreased viscosity. A bread dough with increased water content also results in a bread composition with undesirable size and texture characteristics. There is a need, therefore, for a bread product with a reduced flour content and an increased amount of flavoring ingredient, the flavoring ingredient being of such a nature that it does not deleteriously affect the cohesiveness and structural integrity of the bread. The current state of the art also does not provide a partial or full substitute for flour in a dough composition which is easy to mass produce and is a more efficient source of nutrition than flour.

### SUMMARY OF THE INVENTION

Provided, therefore, is a dough composition, comprised of a dry mixture and water. The dry mixture is comprised of a reconstitutable bean powder, which makes up from about 10% to about 35% by weight of the dry mixture. Flour is also included in the dry mixture, comprising from about 55% to about 70% by weight of the dry mixture. A shortening agent further comprises about 5% to about 15% by weight of the dry mixture. The benefits of this dough composition include reduced flour content and a desirable flavor. Also provided is an ingredient with desirable nutritional and flavor qualities which does not deleteriously affect the cohesiveness and structural integrity of bread. Also provided is a partial substitute for flour in a dough composition, the substitute being easy to produce and providing a more efficient source of nutrition than flour.

Further provided herein is a bread product with reduced carbohydrate content. Also provided is a bread product with desirable flavor characteristics. Still further provided herein is a bread product with increased fiber content. Further provided is a bread product with increased protein content. Further provided is a bread product which retains the extensibility and elasticity of the gluten derived from wheat grain with reduced quantities of gluten present in the dough composition.

Provided in some embodiments is a dough ingredient, including but not limited to bean powder, compositions comprising bean powder, and additives comprising such bean powder, wherein the ingredient comprises a monodispersed reconstitutable bean powder particulate having a mean particle size of about 50 microns to about 250 microns. In certain embodiments the ingredient of the invention can provide flavor and structural integrity to a dough composition.

Also provided in some embodiments is a method of preparing a dough composition. The method includes incorporating an ingredient, including but not limited to bean powder, compositions comprising bean powder, and additives comprising such bean powder, wherein the ingredient comprising a monodispersed reconstitutable bean power particulate having a mean particle size of from about 50 microns to about 250 microns. The methods disclosed herein may further provide flavor and structural integrity to a dough composition.

The dough composition provided herein in certain embodiments may have a reconstitutable bean powder which comprises from about 15% to about 30% by weight of the dry mixture. In a further embodiment of the dough composition, the dough composition comprises reconstitutable bean powder from about 20% to about 25% by weight of the dry mixture. The dough composition as well as the resultant bread product has substantially reduced carbohydrate content in comparison to bread products made with only wheat flour, and has a substantially increased protein and fiber content.

The dough composition of the present invention may be used to prepare a bread product such as a tortilla. It is also contemplated to make other bread products, including bagels, bread, crackers, pitas, muffins, biscuits, pizza shells, pizza crusts, bread, buns, doughnuts, muffins, rolls, cookies, brownies, pancakes, pastas, tortillas, cereals, sheeted snacks, frozen doughs, and various other baked and processed foods.

In another embodiment of the present invention, the dough composition has a reconstitutable bean powder which is comprised of a reconstitutable bean powder particulate having a mean particle size of from about 50 microns to about 250 microns. In certain embodiments, reconstitutable bean powder particulate may have a mean particle size of from about 75 microns to about 200 microns, and in another embodiment, reconstitutable bean powder particulate has a mean particle size of from about 100 microns to about 150 microns.

The dough composition of the present invention may further comprise chemical leavening agents, conditioning agents, shortening agents, salts, additional flavoring ingredients, and sugar. The reconstitutable bean powder particulate may be prepared from a bean such as pinto beans, Great Northern beans, navy beans, red beans, black beans, dark red kidney beans, light red kidney beans, fava beans, green baby lima beans, pink beans, myasi beans, black-eye beans, garbanzo beans, cranberry beans, white beans, rice beans and butter beans.

In another embodiment of the present invention, a dough ingredient which provides structural integrity and flavor to a dough composition may be comprised of a monodispersed reconstitutable bean powder particulate having a mean particle size of from about 75 microns to about 200 microns, or in some embodiments from about 100 microns to about 150 microns. The dough ingredient may be used in a tortilla dough, but also may be used in other dough compositions, including those used to make bagels and pitas.

The reconstitutable bean powder particulate may be used in a dough composition with other dry components in a dry mixture and water. The dry mixture may also include flour, shortening agents, and chemical leavening agents. The ingredient of the present invention is collectively present in the dry mixture of the dough composition in a range from about 10% to about 35% by weight of the dry mixture. The ingredient may also be present collectively in an amount of from about 15% to about 30% by weight of the dry mixture, and in some embodiments in an amount of from about 20% to about 25% by weight of the dry mixture.

### DETAILED DESCRIPTION OF THE INVENTION

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. As such, it is to be understood that the description set forth herein is merely exemplary to the present invention and is not intended to limit the scope of the claims.

Furthermore, certain compositions within the present invention are generally described in the form of ingredients that may be used to produce certain doughs and bread products derived therefrom. It will be understood, however, that the present invention may be embodied in forms and applied to end uses that are not specifically and expressly described herein. For example, one skilled in the art will appreciate that embodiments of the present invention may be incorporated into any food.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total mass weight. When Baker's percentage is used herein, the values are relative to the flour content, i.e., flour comprises 100% of the composition and all the other ingredients are calculated in proportion to the weight of flour; thus, the percentage of the ingredient equals (the weight of ingredient divided by weight of total flour) multiplied by 100. Those of skill in the art recognize that percent mass weight, actual mass weight, and Baker's percentage are all interconvertable.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. The articles “a,” “an,” and “the” are used herein to refer to one or more than one (i.e., to at least one) of the grammatical object of the article. By way of example, “an element” means one or more elements, and thus, possibly, more than one element is contemplated, and may be employed or used.

Provided herein is a dough ingredient, including but not limited to bean powder, compositions comprising bean powder, and additives comprising such bean powder, all of which can provide beneficial flavor and texture characteristics as well as act as a partial substitute for flour which may increase protein and fiber content while reducing carbohydrate content in a bread product. The ingredient comprises a monodispersed reconstitutable bean powder particulate having a mean particle size of about 50 microns to about 250 microns. As used herein “reconstitutable bean powder” comprises compositions having at least monodispersed reconstitutable bean powder particulate, but may additionally comprise other ingredients and additives, such as salt, sugar, and the like. “Monodispersed” as used herein refers to the distribution of size of a particulate. Specifically, monodispersed means that at least about 40% by weight, at least about 60% by weight, at least about 80% by weight or more of the particulate has a largest diameter which is within 60% of the mean particle diameter. “Particle diameter” is the dimensional which is the greatest straight line dimension in the largest plane taken through a three dimension particulate. For example, when the particulate is a sphere, the particulate diameter is the diameter of the sphere, and when the particulate is cube-shaped, the particulate diameter is a line drawn between opposing vertices; that is, the longest solid dimension in the particulate. In one embodiment, monodispersability means that at least 40% of the particulate is within 50% of the mean particulate diameter and, in another embodiment, within 40% of the mean particulate diameter.

“Reconstitutable” as used herein refers to a particulate prepared from minimally the following steps: 1) hydration, 2) cooking, and then 3) dehydration. In order to produce a particulate in a predetermined optimal size range, the reconstitutable particulate is also typically reduced in size by a physical mechanism, such as shredding, comminuting, pulverizing, milling, grinding, or other methods known in the art. Additional steps may be included in production of a reconstitutable particulate, as can be appreciated by the following detailed description and examples. A method of making a reconstitutable bean product is disclosed in commonly-owned U.S. Patent Publication No. 2002/0136811, herein incorporated by reference in its entirety.

As used herein, “reduced carbohydrate content” refers to dough, and bread products derived therefrom, comprising an ingredient of the invention wherein the carbohydrate content of the dough or bread products derived therefrom is less than that of the same dough or bread product of the same mass but made without the ingredient of the invention, and thus includes where the ingredient of the invention has been substituted for all or part of the flour content.

As used herein, “increased protein content” refers to dough, and bread products derived therefrom, comprising an ingredient of the invention wherein the protein content of the dough or bread products derived therefrom is greater than that of the same dough or bread product of the same mass but made without the ingredient of the invention, and thus includes where the ingredient of the invention has been substituted for all or part of the flour content.

As used herein, “increased fiber content” refers to dough, and bread products derived therefrom, comprising an ingredient of the invention wherein the fiber content of the dough or bread products derived therefrom is greater than that of the same dough or bread product of the same mass but made without the ingredient of the invention, and thus includes where the ingredient of the invention has been substituted for all or part of the flour content.

A “chemical leavening agent” as used herein refers to collectively an acid and a base which may be used in a bread composition to provide a chemical reaction which forms a gas in order to expand the dough composition. The gas formed is generally carbon dioxide, and many different acid-based combinations may be used as the leaving agent. Some examples include, but are not limited to, sodium aluminum phosphate, sodium acid pyrophosphate, monocalcium phosphate and ammonium bicarbonate, and sodium aluminum sulfate.

A “shortening agent” as used herein refers to an agent, usually a fat or oil, which is used in a dough composition to provide a crust, or slightly harder edge surface to the bread. Some examples include, but are not limited to, butter, vegetable oils, margarine, and other shortening agents well known in the art.

The reconstitutable bean powder particulate may have a mean particle size of from about 50 microns to about 250 microns, from about 75 microns to about 200 microns, and in some embodiments, be about 125 microns or more. The size of the particulate is significant as it has been found that any particulate acting as a flour substitute must have binding characteristics, as well as provide structural integrity to the composition. If a particulate is too large, it may not be suitable as a flour substitute as it does not have the appropriate size characteristics to function collectively with other particulates and is more like a discrete piece. If the flour substitute is too small, it will similarly not function as a flour substitute. It has been found that reconstitutable bean powder particulate, when utilized at the optimal diameter ranges, has yielded dramatically unexpected results, as it has acted as a partial substitute for flour, providing a bread composition with improved flavor characteristics while also sufficiently binding the bread together to provide a bread product.

In the process of making a reconstitutable bean powder particulate, a precooking step has been found to be advantageous to developing a particulate with binding properties similar to flour, as the cooking step may partially or completely gelatinize the starch and fiber of the beans. It has further been found advantageous to prehydrate the beans prior to the cooking step. This is counter-intuitive, as the particulate is subsequently dehydrated to form a dehydrated finished product. In some instances, it has been found useful to add additional raw gluten to a dough composition if a large amount of flour has been substituted from the composition. A number of additional steps may also be included in the process of making reconstitutable bean powder particulate as set forth below.

Although typically beans of many varieties are used to form such a product, virtually any type of legume may be processed to form a reconstitutable food product, such as reconstitutable bean powder particulate. For example, species of green and yellow peas (Pisum) and lentils (e.g., Lens vulgaris) may be processed. Other legume genuses and varieties are also useful for processing. For example, legumes of oilseed plants, such as soybeans (Glycine max), peanuts (Arachis hypogaea), and trefoil (Lotus corniculatus), may be processed by the methods described herein. Phaseolus, or common bean varieties, may also be processed. In some embodiments of the invention, legumes of pulse plants can be used for processing, such as pinto beans, Great Northern beans, navy beans, red beans, black beans, dark and light red kidney beans, fava beans, green baby lima beans, pink beans, myasi beans, black-eyed beans, garbanzo beans, cranberry beans, white beans, rice beans, butter beans, and the like. Combinations of beans, such as the foregoing, may also be processed.

The process of making the particulate of the present invention includes a process for the production of reconstitutable bean products comprising (a) conditioning the legumes by subjecting the legumes to hydration; (b) cooking the legumes in a continuous advanced flight pressure vessel; (c) depressurizing the cooked legumes in a hydrostatic loop; and (d) dehydrating the legumes to form a reconstitutable bean product.

The process is further drawn to the production of reconstitutable bean products comprising (a) continuous conditioning of the legumes by subjecting the legumes to hydration; (b) cooking the legumes in a continuous advanced flight pressure vessel; (c) depressurizing the cooked legumes in a chilled or hot hydrostatic loop; and (d) dehydrating the legumes to form a reconstitutable bean product.

It is also contemplated to employ a continuous advanced flight rotary drum blancher for conditioning the legumes and a continuous advanced flight pressure vessel in the preparation of reconstitutable bean products. The advanced flight mechanisms ensure that the product is advanced continuously through the conditioning and cooking steps without subjecting the legumes to handling procedures that could shear or crush the legumes.

The process further comprises washing and destoning raw legumes; carrying out the hydration in a continuous advanced flight rotary drum blancher in one, two or more stages; cooking the legumes in a continuous advanced flight pressure vessel; depressurizing the cooked legumes in a hydrostatic loop; and dehydrating the legumes in a one, two or more stage drying process to form a reconstitutable bean product. An organic acid addition may also be incorporated into the hydration/blanching step and/or the cooking step of this process.

In another embodiment, the process for the production of reconstitutable bean products comprises: (a) blanching legumes in water for a period of time; (b) tempering the blanched legumes for a period of time; (c) cooking the tempered legumes in water for a period of time in the presence of an organic acid; and (d) dehydrating the cooked legumes to form a reconstitutable bean product.

The process further includes a method for the production of reconstitutable bean products comprising: (a) blanching legumes in water for a period of time; (b) tempering the blanched legumes for a period of time; (c) cooking the tempered legumes in water for a period of time; and (d) dehydrating the cooked legumes to form a reconstitutable bean product; wherein an organic acid is added to the blanching water, to the cooking water, or to both.

The use of organic acids or their salts during the processing of dehydrated legumes enables the production of dehydrated legumes that are similar in color, texture and appearance to legumes prepared under traditional methods, such as canned beans or preparations from dry bag beans.

The legumes are harvested, cleaned, sorted, dried and put into storage until ready for further processing. At this time the legumes are resorted and washed to remove stones or loose dirt. The legumes may then be blanched at a temperature of about 50° C. to about 100° C. or, in some embodiments, at a temperature between about 60° C. and about 85° C. The blanching may take place for a time period of about 10 minutes to about 50 minutes, about 10 minutes to about 40 minutes, or from about 20 minutes to about 40 minutes, and the like. The temperature of the blanch water may be varied over time to achieve the desired finished texture of the product.

An organic acid or its salt may be added to either the blanch water, the cook water, or both, at an amount ranging between about 0.1% to about 5% or, in some embodiments, from about 0.2% to about 3%. The organic acids that may be employed at this stage, or at the cooking stage, or at both stages, include one or more of acetic acid, citric acid, gluconic acid, gluconolactonic acid, lactic acid, ascorbic acid, malic acid their salts, and mixtures thereof.

Calcium chloride may be added to the blanch water at about 0.1% to about 1% of volume of the water, and may be added at about 0.2% to about 0.7%. The amount of acid or salt added, such as calcium chloride, may also be based on the dry weight of the legumes, thereby adding about 0.5% to about 10% calcium chloride to the blanch water and in some embodiments about 1% to about 5% calcium chloride. The legumes may then be tempered for about 10 minutes to about 90 minutes, or about 20 minutes to about 45 minutes, or any other appropriate amount of time. The tempering may be performed at the as-is temperature when the product is removed from the blanching process. The legumes may then be cooked in water at an appropriate temperature (for example, between about 100° C. to about 125° C. or, in some embodiments, from about 105° C. to about 120° C.) for an appropriate amount of time, such as about 10 minutes to about 60 minutes, about 10 minutes to about 45 minutes, about 20 minutes to about 45 minutes, and the like.

The organic acids may also be added at the cooking stage in the same amounts as described supra. The organic acids, as disclosed, may be added at the cooking stage. As stated above, an organic acid or its salt may be added to the cook water at between 0.2% and 3%. The organic acids that may be added at the cooking step include one or more of acetic acid, citric acid, gluconic acid, gluconolactonic acid, lactic acid, ascorbic acid, malic acid, their salts and mixtures thereof. Sugar, glycerine and/or sorbitol may be added to the cook water at an amount between about 0.5% and about 10%, based on the weight of the dry legumes. The sugar, glycerine and/or sorbitol may be added at an amount between about 2% and about 10% and, in some embodiments, from about 2% to about 6%. Salt may also be added to the cook water at between about 0.1% and about 10%, based upon the dry weight of the legumes, and in some embodiments, between about 0.1% and about 5%.

The legumes may then be removed from the cooker and dried under conditions practiced in the industry, as described infra. The organic acids added at either or both of the blanching and cooking steps help to maintain the nutritional qualities of the legumes by not allowing complete denaturation of proteins and sugars encapsulated within the seed coat. Therefore, soluble product losses are minimized. The addition of the organic acid further reduces the discoloration of the finished legumes after drying and preparation, as well as prevents the skins from cracking and disassociating from the product.

Also provided is a process for the production of reconstitutable bean products comprising (a) conditioning the legumes by subjecting the legumes to hydration; (b) cooking the legumes in a continuous advanced flight pressure vessel; (c) depressurizing the cooked legumes in a hydrostatic loop; and (d) dehydrating the legumes to form a reconstitutable bean product.

The invention is further drawn to a process for the production of reconstitutable bean products comprising (a) continuously conditioning the legumes by subjecting the legumes to continuous advanced flight hydration; (b) cooking the legumes in a continuous advanced flight pressure vessel; (c) depressurizing the cooked legumes in a chilled or hot hydrostatic loop; and (d) dehydrating the legumes to form a reconstitutable bean product.

For this facet of the invention, the raw legumes may be washed and destoned. This step may be performed for a period of about 1 to about 10 minutes, about 1 minute to about 5 minutes, from 2 minutes to 4 minutes, or any other appropriate amount of time. The legumes may be immersed in water so that chaff, sticks and pod material are floated off and dirt and stones are removed through a series of riffles. Legumes of lower quality may also be removed.

Following washing and destoning, the legumes may be conditioned. This can be a one, two or more stage process. Conditioning in hot or cold water will modify flavor and/or color. Additionally, process additives, such as calcium chloride or sodium hexmet phosphate, can be added to enhance processing. The legumes may be conditioned by hydration in a two-stage process. This process may take place in an advanced flight rotary drum blancher as a continuous process. If there are multiple stages of conditioning, the legumes may be moved from one stage to the next as the legumes are moved through the rotary drum. In the process, the legumes are immersed in water during the first stage of conditioning. The legumes may then be moved through the water by the advanced flighting with modified blanching temperatures.

The conditioning that follows the washing/destoning step may be a two-step hydration process which takes place in a continuous advanced flight blancher. In the heated water process, the legumes may be first immersed in water heated to about 38° C. to about 102° C. or, in some embodiments, from about 43° C. to about 99° C. or, in some other embodiments, from about 49° C. to about 74° C. The legumes may then be subjected for a second period of time to water at a higher temperature of about 52° C. to about 108° C., about 54° C. to about 99° C., about 63° C. to about 93° C., or any other appropriate termperature. The conditioning process can also take place in cold water, which fixes product colors.

In a cold water conditioning process, the legumes may be initially immersed in water at about 2° C. to about 38° C., about 4° C. to about 35° C., about 7° C. to about 29° C., or any other appropriate temperature. The legumes may then be subjected for a second period of time to water at a higher temperature of about 4° C. to about 62° C., about 10° C. to about 57° C., about 13° C. to about 52° C., or any other appropriate temperature.

The conditioning process may take about 5 minutes to about 3 hours, about 10 minutes to about 2 hours, about 15 minutes to about 60 minutes, or any other appropriate time, in the case of high-temperature conditioning. With cold water conditioning, this process can take from about 30 minutes to about 4 hours, about 1 hour to about 3 hours, or any other appropriate amount of time. During conditioning, the legumes may be hydrated and evenly blanched due to the continuous advanced flighting process.

Any remaining stones and low-quality legumes may be removed following conditioning by density separation methods which will remove any low-quality beans and stones that were not removed during the initial washing/destoning step. Only high-quality legumes remain to be formed into the reconstitutable bean product. The density separation takes about 1 to about 20 minutes, about 1 to about 10 minutes, about 1 to about 3 minutes, or any other appropriate amount of time.

After the density separation, the legumes may be optionally subject to live belt storage, or tempering, in order to stabilize the moisture within the legumes. After tempering, the products may be conveyed through an open channel air lock into an advanced flight pressure vessel where the legumes are cooked. The tempering takes place for a period of about 10 minutes to about 3 hours, about 20 minutes to about 2 hours, about 30 minutes to about 1 hour, or any other appropriate amount of time.

The cooking step may be performed using a continuous advanced flight pressure vessel where further processing additives can be added, such as salt, organic acids or their salts and/or sugar, along with other types of processing agents. The pressure vessel comprised of a rotating advanced flighted reel within a static outer shell. The flighted reel rotates within the static outer shell on a set of trunions under pressure to cook the beans from about 10 minutes to about 2 hours, about 15 to about 90 minutes, about 25 to about 75 minutes, or any other appropriate amount of time, at a temperature of about 93° C. to about 149° C., about 110° C. to about 141° C., about 118° C. to about 124° C., or any other appropriate temperature. The cooker may comprise several sets of flights through which the legumes are continuously moved during cooking. For example, in some embodiments, there are three sets of ten flights; the first and third are without agitation with the middle set of flights having subtle agitation lifters within the flights rolling the product gently. An internal reel with flighting moves the legumes continuously through the cooker as it turns, therefore being able to control the retention within the processing reel. As the product moves through the reel, the product continues to gain mass; therefore, the last set of flights may be spaced farther apart to eliminate the shearing effects of added weight. The outer shell may be static and maintain the pressure from about 10 PSI to about 25 PSI, both within and outside of the internal reel. The pressure may be maintained at about 11 PSI to about 20 PSI, may be from about 12 PSI to about 17 PSI. Since the legumes are moved continuously through the cooker, there is no chance for the legumes to be in contact with mixing blades or to fall back upon the mixture during the final stages of cooking. This prevents the shearing and crushing of the legume product as it is moved continuously through the cooker. The cooking time can be controlled through the speed of the advanced flighting rotation through the cooker.

After cooking, the legume products may then be conveyed continuously into the decompression bucket leg or hydrostatic loop. This decompression leg maintains the pressure within the pressure vessel by providing a head of chilled or hot water. At this time, the legumes may be depressurized through a water column to keep the legume intact and allowing the legume product to stabilize thermodynamically. The legumes enter the hydrostatic loop and may be passed through sterilized chilled or hot water for about 1 to about 15 minutes, about 1 to about 10 minutes, about 2 to about 8 minutes, or some other appropriate amount of time. The legumes rise through the water, undergoing a slow decompression. The temperature at which chilled decompression takes place is about 2° C. to about 23° C., about 4° C. to about 21° C., about 7° C. to about 18° C., or some other appropriate temperature. Hot water decompression may take place at a temperature of about 54° C. to about 101° C., about 62° C. to about 93° C., at about 73° C. to about 85° C., or some other appropriate temperature. Alternatively, the chilled decompression takes place at about −1° C. to about 12° C., about 1° C. to about 7° C., about 1° C. to about 4° C., or some other appropriate temperature. Decompression at lower temperatures may be advantageous because since the thermal activity is also stopped using chilled water, which aids in slow decompression. Slow decompression of the legumes may be a significant factor normal depressurization of legume products tends to puff or explode the legumes.

Following decompression, the cooked legumes may then be subject to a form of comminuting either by Fitzmill, Comitrol, flaking, and/or blending by passing the legumes through prior to drying. One set of flaking rolls may be used. The drying process for the comminuted bean products may take place in one, two or more stages and involves the use of bidirectional airflow at moderate temperatures utilizing long-term drying. The entire drying process can last from about 5 minutes to about 60 minutes. The drying temperature may drop throughout the range over the drying period.

The legumes can be comminuted prior to drying by any of several processes, such as Fitzmill, Comitrol, pumping, blending and/or flaking. One set of flaking rolls may be placed so that a gap of about 0.004 inches (100 microns) to about 0.25 inches (6,350 microns), about 0.010 inches (250 microns) to about 0.10 inches (2,540 microns), about 0.012 inches (300 microns) to about 0.030 inches (760 microns), or some other appropriate distance which allows for quick preparation. Although the size of the flaker gap will determine the size of the particulate, further processing techniques may be employed in addition to the comminuting process in order to achieve the desired particulate size and have an impact on its efficacy. Following flaking, the legumes may be subject to an indirect steam-heated two- to three-stage dryer with multiple zones using bidirectional airflow through the product bed. By using a multiple-stage dryer, a higher quality product can be produced. The process may be a two-stage process. Drying may take place initially at temperatures from about 93° C. to about 148° C., about 101° C. to about 140° C., or some other appropriate temperature, at a humidity level of about 0% to about 45% RH, about 10% to about 40% RH, about 25% to about 35% RH, or some other appropriate relative humidity. The first stage drying can be followed by a second stage drying at temperatures from about 132° C. to about 65° C., about 71° C. to about 126° C., or some other appropriate temperature with the humidity in the second stage of about 0% to about 20% RH, about 2% to about 15% RH, about 3% to about 10% RH, or some other appropriate relative humidity. The drying time for each stage can be about 5 minutes to about 60 minutes, about 10 minutes to about 50 minutes, about 15 minutes to about 30 minutes, or any other appropriate amount of time. The dehydrated legumes are then sized and/or sorted and packaged for use.

### EXAMPLES

The following are examples of compositions of the invention, including, for example, tortillas. The examples are not meant to limit the scope of the invention, as defined by the claims.

### Example 1

A tortilla dough composition was prepared using the following specifications. First the components were mixed together in a dough composition. 300 grams of flour (10.8%-11.5%) protein was mixed with 22 grams of ADM Arkady flour tortilla base, 35 grams of tortilla shortening (Golden Chef™ ADM, Decatur Ill.), 75 grams of reconstitutable bean powder (mean particle size 50 microns) made from Great Northern beans, 2 grams of salt, and 293 grams of water. All dry ingredients and shortening ingredients were mixed prior to the addition of water. Mixing of the dry mixture was conducted in a mixer for 3-5 minutes on a low speed setting. Water was then added and the dough composition was mixed at a slow speed for approximately 1 minute and a high speed for approximately 5 minutes. The temperature of the dough at this time was approximately 320 to 38° C. The dough was then formed into two ounce dough balls by hand and allowed to sit for 15 minutes. The dough balls were then pressed by a tortilla press and then cooked for 45 to 60 seconds at approximately 252° C.

### Example 2

A tortilla dough composition was prepared using the following specifications. First the components were mixed together in a dough composition. 300 grams of flour (10.8%-11.5% protein) was mixed with 22 grams of ADM Arkady flour tortilla base, 35 grams of tortilla shortening, 75 grams of reconstitutable bean powder (mean particle size 50 microns) made from navy beans, 2 grams of salt, and 293 grams of water. All dry ingredients and shortening were mixed in a mixer for 3-5 minutes on low. Water was then added and the dough composition was mixed at a slow speed for 1 minute and high speed for 5 minutes. The temperature of the dough was approximately 32-38° C. The dough was then formed into two-ounce balls by hand and allowed to sit for 15 minutes. The dough balls were then pressed by a tortilla press and subsequently cooked for 45 to 60 seconds at approximately 252° C.

### Example 3

A third tortilla dough composition was prepared using the following specifications. The components were mixed together in a dough composition, first the dry mixture followed by the addition of water. 400 grams of flour (10.8%-11.5% protein) was mixed with 24 grams of ADM Arkady flour tortilla base, 50 grams of tortilla shortening, 16 grams of Provim ESP® gluten (ADM, Decatur, Ill.), 160 grams of reconstitutable bean powder (mean particle size 50 microns) made from black beans, 8 grams of baking powder, 3 grams of salt, and 440 grams of water. The dry mixture was creamed in a mixer for 3-5 minutes on low. Water was then added to the dry mixture and the entire composition was mixed in a mixer on slow speed for 1 minute and on high speed for 5 minutes. The temperature of the dough was approximately 32-38° C. The dough was then formed into two-ounce balls by hand and allowed to sit for 15 minutes. The dough balls were then pressed by a tortilla press and then cooked for 45 to 60 seconds at approximately 252° C.

### Example 4

A fourth tortilla dough composition was prepared using the following specifications. The dry components were first mixed together into a dry mixture composition. 300 grams of flour (10.8%-11.5% protein) was mixed with 24 grams of ADM Arkady flour tortilla base, 40 grams of tortilla shortening, 120 grams of a reconstitutable bean powder (mean particle size 50 microns) made from black beans, 3 grams of baking powder, 1.5 grams of salt, and 320 grams of water. The dry ingredients were mixed together in a mixer for 3-5 minutes on low. The dry mixture was then mixed with water in a mixer at slow speed for 1 minute and at high speed for 5 minutes. The temperature of the dough was approximately 32-38° C. The dough was then formed into two-ounce dough balls by hand and allowed to sit for 15 minutes. The dough balls were then pressed by a tortilla press and then cooked for 45 to 60 seconds at approximately 252° C.

### Example 5

A fifth tortilla dough composition was prepared using the following specifications. 400 grams of flour (10.8%-11.5% protein) was mixed with 32 grams ADM Arkady flour tortilla base, 50 grams of tortilla shortening, 160 grams of reconstitutable bean powder (mean particle size 50 microns) made from red beans, 2 grams of baking powder, 2 grams of salt, and 430 grams of water. The mixing of the dry mixture was conducted in a mixer for 3-5 minutes on low. Water was then added and the dough composition was mixed at a slow speed, approximately 1 minute and 5 minutes on high speed. The temperature of the dough was approximately 32-38° C. The dough was then formed into two-ounce dough balls by hand and allowed to sit for 15 minutes. The dough balls were then pressed by tortilla press and then cooked for 45 to 60 seconds at approximately 252° C.

### Example 6

A tortilla dough composition was prepared using the methods of Example 1. The formula in Table 1 shows the mixture of the various ingredients. The Black Bean Tortilla Base™ (ADM Arkady, Olathe, Kans.) comprised reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 1

| Ingredients | Grams |
|---|---|
| Flour | 400 |
| Water | 370 |
| Black Bean Tortilla Base ™ | 128 |
| Tortilla Shortening (Golden Chef Tortilla | 50 |
| Shortening ™, ADM, Decatur IL) | |
| Salt | 2 |

### Example 7

A tortilla dough composition was prepared using the methods of Example 1. The formula in Table 2 shows the mixture of the various ingredients. The Black Bean Tortilla Base as shown in Table 3 comprises reconstitutable black bean powder as shown in Table 2.

TABLE 2

| Ingredients | Percent (Baker's Percentage) |
|---|---|
| Flour | 100 |
| Water | 92.5 |
| Black Bean Tortilla Base | 32 |
| as shown in Table 4 | |
| Shortening | 12.5 |
| Salt | 0.5 |

TABLE 3

| Ingredient | Percent (Dry Weight) |
|---|---|
| Reconstitutable Black Bean Powder | 77.906 |
| Salt | 6.10 |
| Cornstarch | 3.30 |
| Sodium bicarbonate | 3.10 |
| Calcium propropionate | 2.19 |
| Fumaric acid | 1.40 |
| Sodium Acid Pyrophosphate Rate 28 | 2.19 |
| Sodium Stearoyl Lactylate | 1.30 |
| Encapsulated fumaric acid | 1.20 |
| Guar gum | .55 |
| 90% mono- and di-glycerides | .55 |
| Inactive dry yeast | .20 |
| L-cysteine HCL | .014 |

### Example 8

A tortilla dough composition was prepared using the methods of Example 1. The formula in Table 4 shows the mixture of the various ingredients. The Black Bean Tortilla Base™ (ADM Arkady, Olathe, Kans.) comprises reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 4

| Ingredient | Percent (Baker's Percentage) |
|---|---|
| Flour | 100 |
| Water | 92.5 |
| Black Bean Tortilla Base ™ | 32 |
| Tortilla shortening (Golden | 12.5 |
| Chef ™, ADM, Decatur IL) | |
| Salt | 0.5 |

### Example 9

A tortilla dough composition was prepared using the methods of Example 1. The formula in Table 5 shows the mixture of the various ingredients and the effect of varying the ingredients in adjusting the pH. It was found that removing the baking powder lowered the pH of the mix from 5.82 to 5.71 (Table 5A). It was also found that adding fumaric acid at 0.1% (based on flour) further lowered the pH to 5.58 (Table 5B). The Black Bean Tortilla Base™ (ADM Arkady, Olathe, Kans.) comprised reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 5

| | A | B |
|---|---|---|
| | Grams | Grams |
| Flour | 200 | 200 |
| Water | 185 | 185 |
| AZ Tortilla Base ™ (ADM | 14 | 14 |
| Arkady, Olathe, KS) | | |
| Shortening | 25 | 25 |
| Salt | 1.5 | 1.5 |
| Black Bean Tortilla Base ™ | 50 | 50 |
| Baking powder | — | — |
| Fumaric acid | — | .2 |
| pH → | 5.71 | 5.58 |

### Example 10

Tortilla dough compositions were prepared using the methods of Example 1. The formula in Table 6 shows the mixture of the various ingredients. The Black Bean Tortilla Base™ (ADM Arkady, Olathe, Kans.) comprised reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Red Bean Tortilla Base is comprised of red bean powder (red beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Great Northern Bean Tortilla Base is comprised of great northern bean powder (Great Northern beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 6

| | A | B | C |
|---|---|---|---|
| Ingredients | Grams | Grams | Grams |
| Bread flour | 300 | 400 | 300 |
| Water | 330 | 450 | 285 |
| Black Bean Tortilla Base ™ | 120 | — | — |
| Shortening | 40 | 50 | 35 |
| Baking powder | 3 | 2 | — |
| Salt | 1.5 | 2 | 2 |
| AZ Tortilla Base ™ (ADM | 24 | 32 | 22 |
| Arkady, Olathe, KS) | | | |
| Red Bean Tortilla Base | — | 160 | — |
| Great Northern Bean | — | — | 75 |
| Tortilla Base | | | |

### Example 11

A tortilla dough composition was prepared using the methods of Example 1. The formula in Table 7 shows the mixture of the various ingredients. The Black Bean Tortilla Base™ (ADM Arkady, Olathe, Kans.) comprised reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Red Bean Tortilla Base is comprised of red bean powder (red beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Great Northern Bean Tortilla Base is comprised of Great Northern bean powder (Great Northern Beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Navy Bean Tortilla Base is comprised of navy bean powder (navy beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 7

| | A | B | C | D | E |
|---|---|---|---|---|---|
| Ingredients | Grams | Grams | Grams | Grams | Grams |
| Water | 320 | 440 | 430 | 285 | 285 |
| AZ Tortilla Base ™ | 24 | 24 | 32 | 22 | 22 |
| (ADM Arkady, | | | | | |
| Olathe, KS) | | | | | |
| Shortening | 40 | 50 | 50 | 35 | 35 |
| Black Bean | 120 | 160 | — | — | — |
| Tortilla Base ™ | | | | | |
| Red Bean | — | — | 160 | — | — |
| Tortilla Base | | | | | |
| Bread flour | 300 | 400 | 400 | 300 | 300 |
| Baking powder | 3 | 8 | 2 | — | — |
| Salt | 1.5 | 3 | 2 | 2 | 2 |
| Gluten | — | 16 | — | — | — |
| Great Northern | — | — | — | 75 | — |
| Bean Tortilla Base | | | | | |
| Navy Bean | — | — | — | — | 75 |
| Tortilla Base | | | | | |

### Example 12

A tortilla dough composition was prepared using the methods of Example 1. The recipe in Table 8 shows the mixture of the various ingredients. The Black Bean Tortilla Base™ (ADM Arkady, Olathe, Kans.) comprised reconstitutable black bean powder (black beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL. The Red Bean Tortilla Base is comprised of red bean powder (red beans, sugar, and calcium chloride), salt, sodium bicarbonate, fumaric acid, calcium propionate, sodium acid pyrophosphate, cornstarch, sodium stearoyl lactylate, guar gum, monoglycerides, yeast, and L-cysteine HCL.

TABLE 8

| | A | B |
|---|---|---|
| Ingredients | Grams | Grams |
| Flour | 400 | 500 |
| Water | 370 | 460 |
| Fat | 50 | 55 |
| Salt | 3 | 3 |
| Black Bean Tortilla Base ™ | 100 | — |
| Red Bean Tortilla Base | — | 125 |
| Reconstitutable Black Bean Powder | 2 | 2.5 |
| AZ Tortilla Base ™ (ADM Arkady, | 28 | 35 |
| Olathe, KS) | | |
| Habanero | — | 5 |

It will be appreciated by those skilled in the art that changes could be made to the embodiments described herein without departing from the broad concept of the invention. It is understood, therefore, that this invention is not limited to the particular embodiments disclosed, but is intended to cover modifications that are within the spirit and scope of the invention as defined by the claims.

We claim:

1. A dough composition comprising a dry mixture and water, the dry mixture comprising:
a reconstitutable bean powder comprising from 10% to 35% by weight of the dry mixture,
flour comprising from 55% to 70% by weight of the dry mixture, and
shortening comprising from 5% to 15% by weight of the dry mixture.

2. The dough composition of claim 1, wherein the reconstitutable bean powder comprises from 15% to 30% by weight of the dry mixture.

3. The dough composition of claim 2, wherein the reconstitutable bean powder comprises from 20% to 25% by weight of the dry mixture.

4. The dough composition of claim 1, wherein the dough composition has increased protein content.

5. The dough composition of claim 1, wherein the dough composition has increased fiber content.

6. The dough composition of claim 4, wherein the dough is a tortilla dough.

7. The dough composition of claim 1, wherein the reconstitutable bean powder comprises monodispersed reconstitutable bean powder particulates having mean particle size of from 50 microns to 250 microns.

8. The dough composition of claim 7, wherein the monodispersed reconstitutable bean powder particulates have a mean particle size of from 75 microns to 200 microns.

9. The dough composition of claim 8, wherein the monodispersed reconstitutable bean powder particulates have a mean particle size of from 100 microns to 150 microns.

10. The dough composition of claim 1, wherein the dough composition further comprises a chemical leavening agent.

11. The dough ingredient composition of claim 1, wherein the reconstitutable bean powder is prepared from a bean selected from the group consisting of pinto beans, Great Northern beans, navy beans, red beans, black beans, dark red kidney beans, light red kidney beans, fava beans, green baby lima beans, pink beans, myasi beans, black-eyed beans, garbanzo beans, cranberry beans, white beans, rice beans, and butter beans.

12. A dough ingredient comprising a monodispersed reconstitutable bean powder particulate having a mean particle size of from 50 microns to 250 microns.

13. The dough ingredient of claim 12, wherein the monodispersed particulate has a mean particle size of from 75 microns to 200 microns.

14. The dough ingredient of claim 13, wherein the monodispersed particulate has a mean particle size of from 100 microns to 150 microns.

15. The dough ingredient of claim 12, wherein the dough ingredient provides structural integrity by displacing flour in a tortilla dough.

16. The dough ingredient of claim 12, further comprising flour, a shortening agent, and a chemical leavening agent, which form a dry mixture.

17. The dough ingredient of claim 16, wherein the ingredient comprises from 10% to 35% by weight the dry mixture.

18. The dough ingredient of claim 17, wherein the ingredient comprises from 15% to 30% by weight of the dry mixture.

19. The dough ingredient of claim 18, wherein the ingredient comprises from 20% to 25% by weight of the dry mixture.

20. The ingredient of claim 12, wherein the monodispersed bean powder particulate is prepared from a bean selected from the group consisting of pinto beans, Great Northern beans, navy beans, red beans, black beans, dark red kidney beans, light red kidney beans, fava beans, green baby lima beans, pink beans, myasi beans, black-eyed beans, garbanzo beans, cranberry beans, white beans, rice beans, and butter beans.

21. A method of preparing a dough composition comprising incorporating an ingredient into the dough composition, the ingredient comprising a monodispersed reconstitutable bean powder particulate having a mean particle size of from 50 microns to 250 microns.

22. A method according to claim 21, wherein the monodispersed particulate has a mean particle size of from 75 microns to 200 microns.

23. A method according to claim 22, wherein the monodispersed particulate has a mean particle size of from 100 microns to 150 microns.

24. A method according to claim 21, wherein the dough composition is a tortilla dough.
